(19) United States
(12) Patent Application Publication
(10) Pub. No.: US 2022/0214607 A1
(43) Pub. Date: Jul. 7, 2022

(54) Folding Screen Frame

(71) Applicant: David Wright, Lakwood Ranch, FL (US)

(72) Inventor: David Wright, Lakwood Ranch, FL (US)

(21) Appl. No.: 17/142,867

(22) Filed: Jan. 6, 2021

(51) Int. Cl. G03B 21/58

(52) U.S. Cl. CPC G03B 21/58

(57) ABSTRACT

An outdoor home theater system that facilitates rapid and easy extension and storage thereof. The home theater system fully encloses a viewing screen for protection of the elements and has two doors that open at its bottom for extension of the viewing screen. The screen is easily retractable using a spring assembly found within the system.

### FIELD OF THE INVENTION

The present invention relates to home theater systems. More particularly, the present invent relates to home theater systems suitable for use outdoors in the patio, screened porch or similar locales.

### BACKGROUND OF THE INVENTION

The modern era presents more and more opportunities for presentation of audio and visual materials to the home users. Various projection type devices have existed in the past and continued improvements in the art will provide enjoyment far into the future.

However, there is no outdoor system, with an easily replaceable, wrinkle free and machine washable screen, that is easily deployable and retractable. Additionally, there is no system that is easily adaptable to lanais in order to facilitate the viewing of movies whilst in the pool on relaxing on one's patio. Nor is their a system that provides complete protection from elements and full extension of the screen in a manner that is both simple and fast.

Accordingly, there remains a need in the art for an outdoor home theater system that facilitates rapid and easy extension and storage thereof. Further, there is a need in the art that fits into an outdoor layout.

### SUMMARY OF THE INVENTION

The present invention overcomes the deficiencies of the known art and the problems that remain unsolved by providing a method and respective apparatus.

A screen system comprising:

a cover having

a screen attached to the cover.

In another aspect, further comprising:

a screen holder disposed within the cover such that the screen is attached to the screen holder.

In another aspect, further comprising:

a retractor attached to the cover and movably attached to the screen and to a screen holder.

In another aspect, further comprising:

a first movable member attached to the cover.

In another aspect, further comprising:

a second movable member attached to the cover.

In another aspect, further comprising:

wherein the first member is locked into position with a portion of a screen holder inserted within the cover and attached to the cover.

In another aspect, further comprising:

wherein a second movable member attached to the cover is locked into position with another portion of the screen holder inserted within the cover and attached to the cover.

In another aspect, further comprising:

a vertical side of the screen attached to the cover using a pulley.

In another aspect, further comprising:

wherein the cover is enclosed and has a lower opening for insertion of a screen holder attached to both the cover and to the screen.

In another aspect, further comprising:

wherein the screen holder is movably attached to the cover.

In another aspect, further comprising:

wherein the screen holder is attached movably to the cover using a retractor and the screen holder is movably attached to the screen using the tractor.

In another aspect, further comprising:

a cable attached to the retractor and threaded within the grommet for further attachment to the screen holder.

A screen covering system comprising:

a cover having a screen attached thereto; and

a screen holder attached to the screen and attached to the cover.

In another aspect, further comprising:

a rail attached to the cover and to the screen.

In another aspect, further comprising:

wherein the screen is attached to the rail.

In another aspect, further comprising:

a door movably attached to a first end of the cover.

In another aspect, further comprising:

a plate attached to the door and to the cover.

In another aspect, further comprising:

a hinge attaching the plate to the door and to the cover.

A container comprising:

a screen attached to and enclosed within the container

wherein the screen is attached to a retractor that is attached to the container.

In another aspect, the theater screen container further comprising:

a first door movably attached to the container lockable into an OPEN mode and a CLOSED mode using locks.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a front view of the closed mode of a Folding Screen Frame with doors hidden within the outside cover in an embodiment disclosed herein.

FIG. 1B presents a front view of the Folding Screen Frame with doors partially rotationally extended beyond the outside cover in an embodiment disclosed herein.

FIG. 1C presents a front view of the Folding Screen Frame with doors fully extended so that the doors extend vertically from the outside cover in an embodiment disclosed herein.

FIG. 1D presents a front view of the Folding Screen Frame with doors completely rotated so that the doors extend vertically and with a partially deployed folding screen and associated screen holder in an embodiment disclosed herein.

FIG. 1E presents a front view of the Folding Screen Frame with doors completely rotated so that the doors extend vertically and so that these are locked into position with locks associated with the deployable screen holder in an embodiment disclosed herein.

FIG. 2A presents a front view of a Folding Screen Frame in an embodiment disclosed with the screen holder fully deployed and locked with the fully deployed vertical doors in an embodiment described herein.

FIG. 2B presents a closeup cross section view as marked in FIG. 2C so as to visualize the location of the retractor wheel 13 attached to the inside top of the outside cover and also shows the beginning of the pulley system within the Folding Screen Frame in an embodiment described herein.

FIG. 2C presents the view described in the middle section of FIG. 2A showing a right looking cross section of the entire Folding Screen Frame with screen and screen holder fully deployed with doors locked with the bottom of the screen holder.

FIG. 2D shows the bottom of the deployed screen holder (as shown in FIG. 2C) in an embodiment described herein. This view also shows the spring plungers in an open position with their respective noses extended.

FIG. 3A presents a side view cross section of the Folding Screen Frame in an embodiment disclosed herein. This view also shows the spring plungers in a closed position with their respective noses retracted inwards.

FIG. 3B presents a front view of a central portion of the outside cover having two small rivets mounting a first plate thereto (a second plate similarly attached); the plate has a central hole through the plate and through a hole in the metal surface of the cover.

FIG. 4A presents a closeup front view of a top front view of the leftmost portion of the Folding Screen Frame shown in FIG. 2A in an embodiment described herein.

FIG. 4B presents a closeup perspective view of the top leftmost portion of the Folding Screen Frame in an embodiment described herein. A cross section of a portion thereof is also shown.

FIG. 5 presents a front view of that sectioned in FIG. 2C showing the screen attached to: pulleys which traverse a cable hidden above doors 5, 6 when doors are closed and attached to the inner top portion of the cover 8, and attached to the bottom of the holder 4 in an embodiment disclosed herein.

FIG. 6 presents a front view of a top left section of FIG. 5 showing how the screen 12 is attached to the inner top portion of the cover 8 and attached to pulleys which traverse a cable hidden above doors 5, 6 when doors are closed in an embodiment disclosed herein.

FIG. 7 presents a bottom left section of FIG. 5 showing how the screen 12 is attached to pulleys which traverse a cable hidden above doors 5, 6 when doors are closed and attached to the screen holder in an embodiment disclosed herein.

FIG. 8A presents an assembly view of the Folding Screen Frame showing how various components come together in an embodiment disclosed herein.

FIG. 8B shows how various features of the upper left of the Folding Screen Frame are assembled in an embodiment disclosed herein. It should be understood that the same features herein described are duplicated on the other side of the Folding Screen Frame.

FIG. 8C shows how various features of the middle of the Folding Screen Frame are assembled in an embodiment disclosed herein.

FIG. 8D shows how various features of the bottom left of the Folding Screen Frame are assembled in an embodiment disclosed herein. It should be understood that the same features herein described are duplicated on the other side of the Folding Screen Frame.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

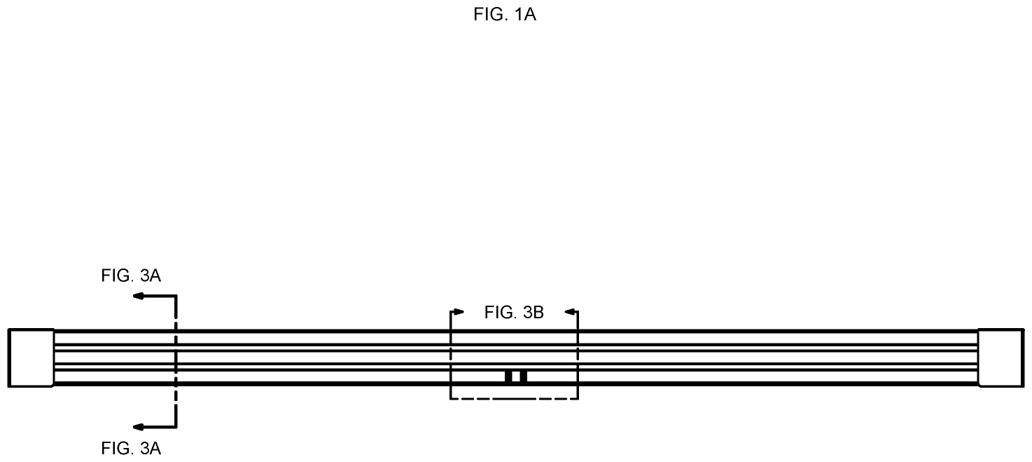

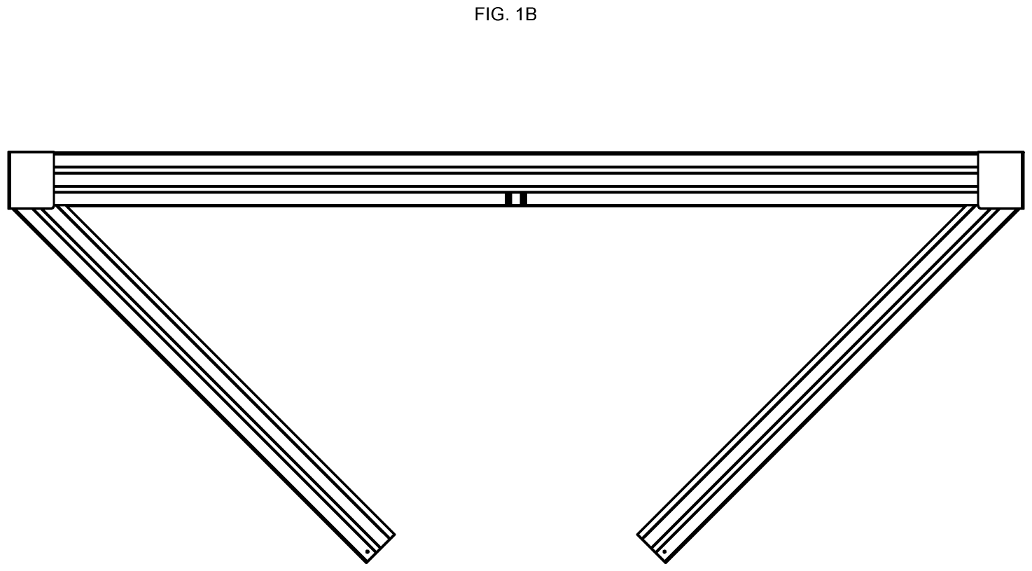

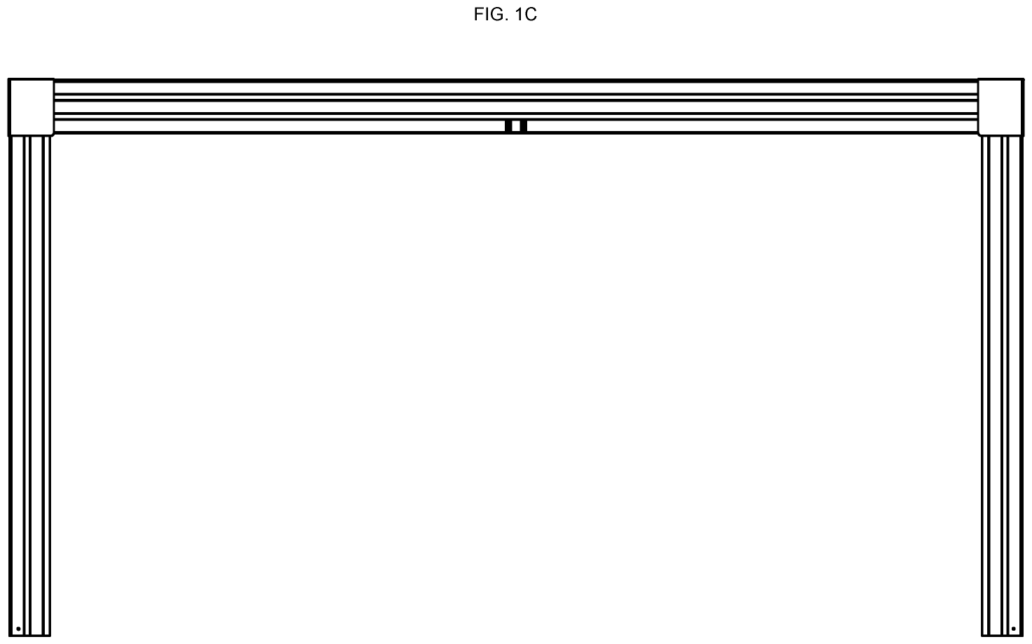

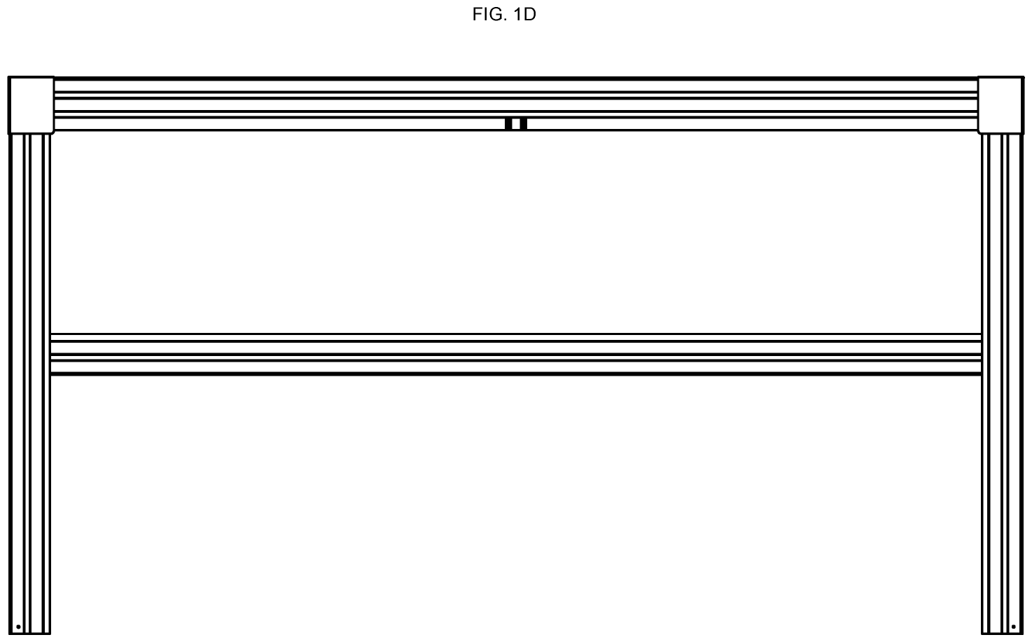

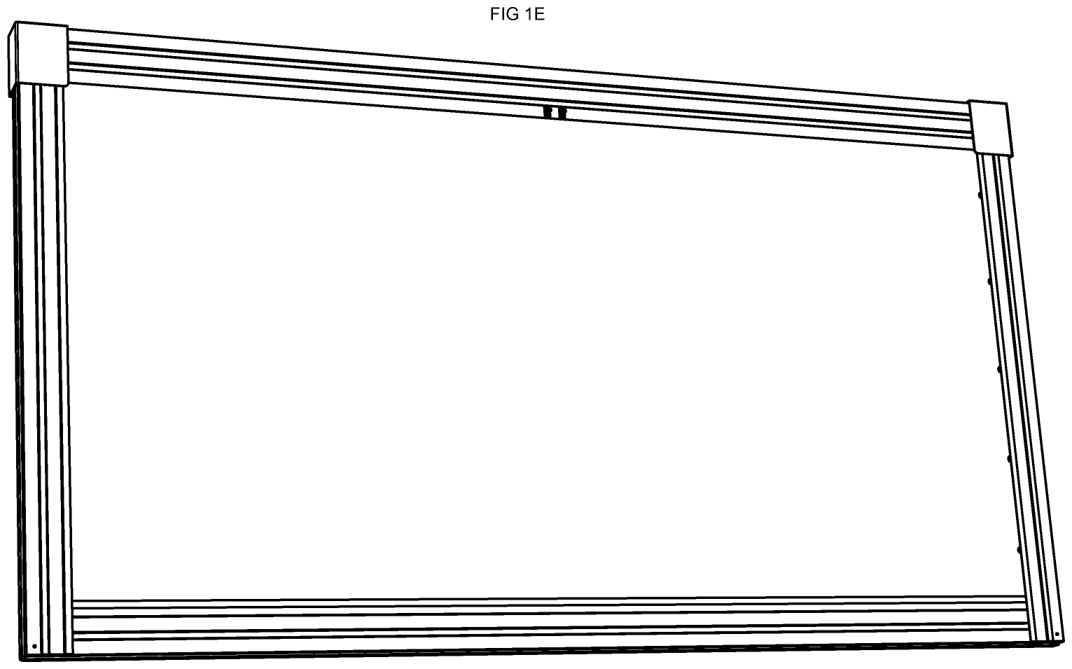

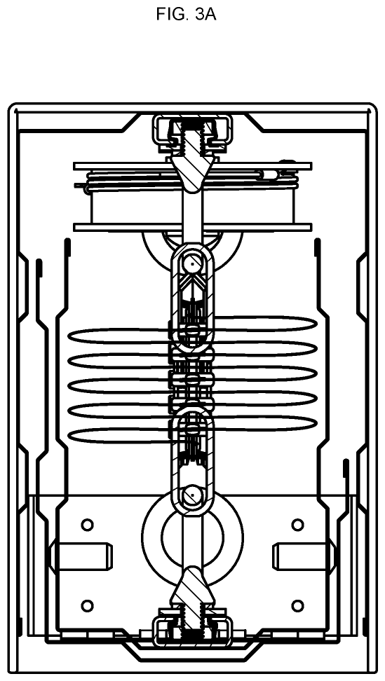

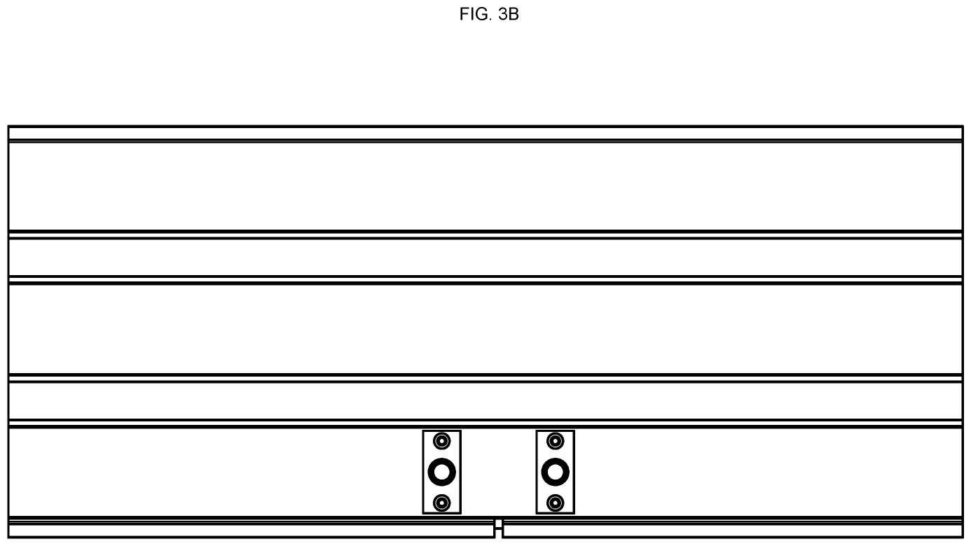

FIG. 1A presents a front view of the closed mode of a Folding Screen Frame with movable doors hidden within the outside cover in an embodiment disclosed herein. The Folding Screen Frame comes with several components including two doors, a cover, dual hinges, screen holder and more as described hereinafter. The image shows how a left looking cross section of the left side of the Folding Screen Frame in a closed position with doors closed is presented in FIG. 3A for more detailed information thereof. Similarly, the image shows a center front view of the Folding Screen Frame as presented in FIG. 3B for more detailed information thereof. The words door or door member are herein interchangeably used.

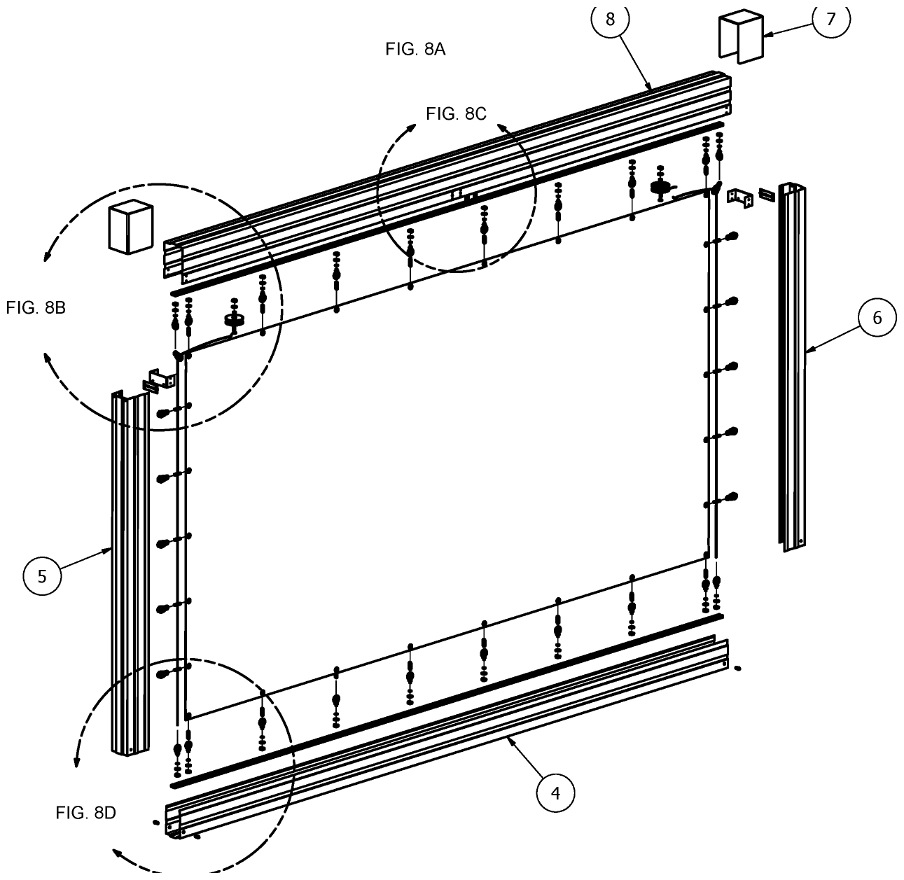

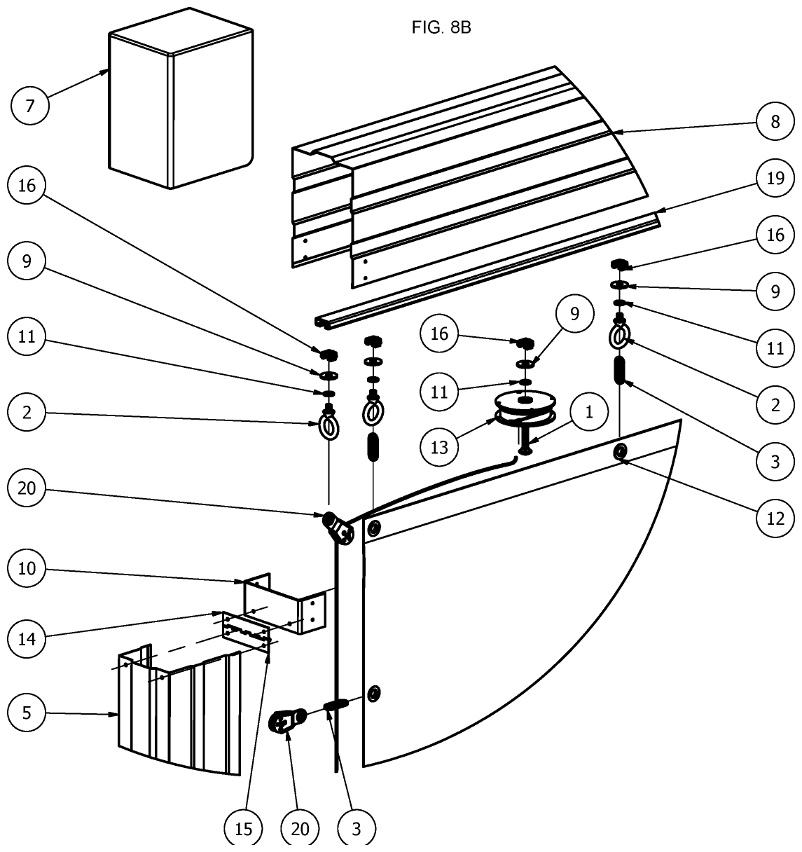

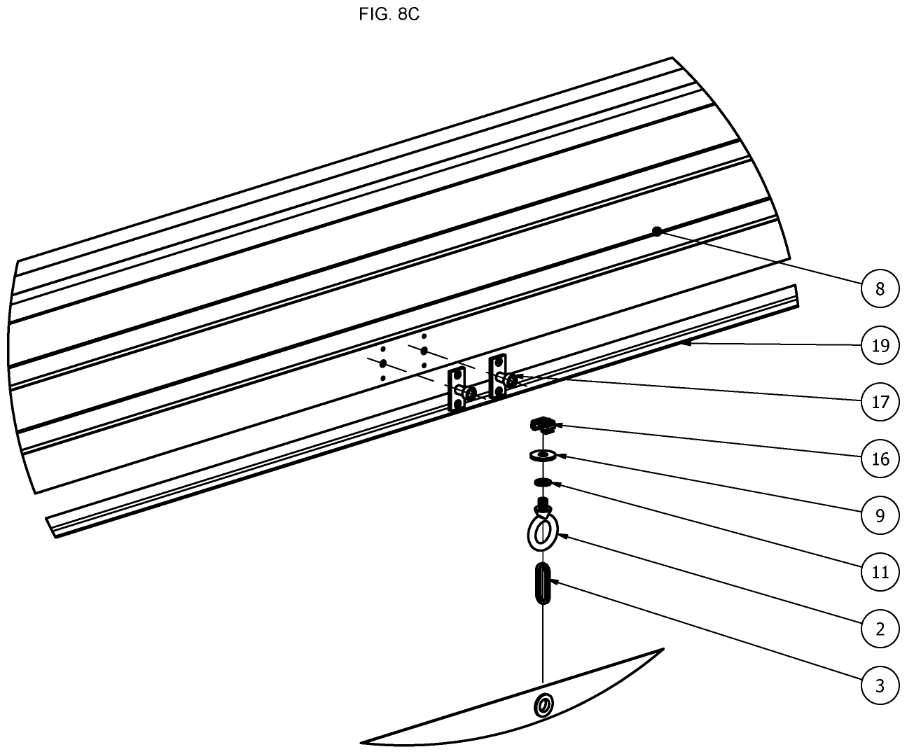

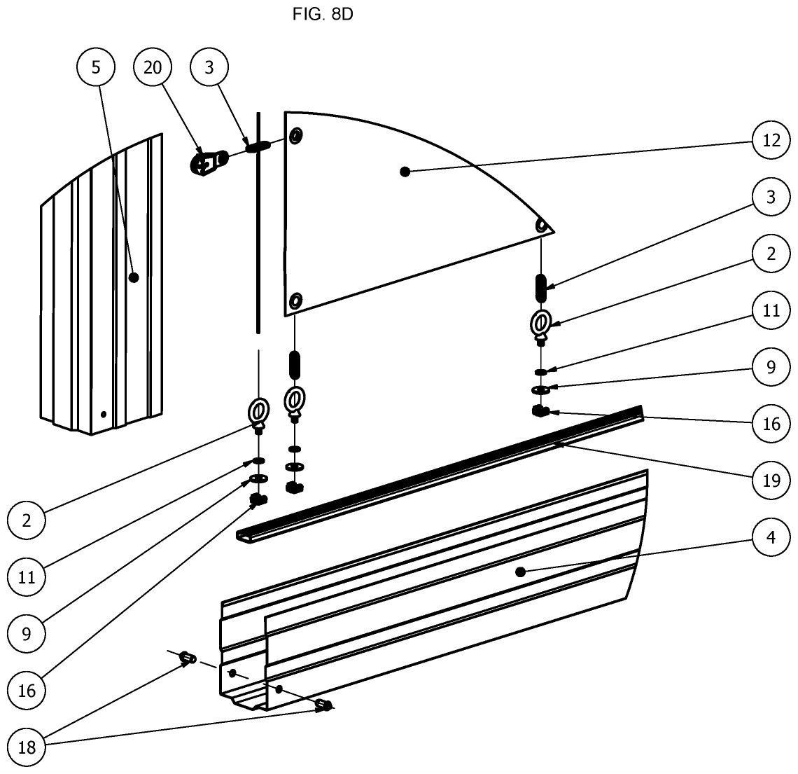

FIG. 1B presents a front view of the Folding Screen Frame with doors partially rotationally extended beyond the cover in an embodiment disclosed herein. Door members 5 and 6 are shown rotationally attached using two hinges (not shown) one for each door member 5, 6; thus, a first door member 5 is attached to aa first hinge plate through a first hinge whilst the first hinge plate itself is attached to a first side of a cover 8. Similarly, the second door member 6 is attached to a second hinge plate through a second hinge whilst the second hinge plate itself is attached to a second side of the cover 8; this such that the first and second sides are opposite one another at the inside opposite ends of the cover. The two identical hinges used to so attach the two door members 5, 6 are attached as described with respect to FIG. 8B.

FIG. 1C presents a front view of the Folding Screen Frame with doors fully extended so that the door members extend vertically from the cover in an embodiment disclosed herein.

FIG. 1D presents a front view of the Folding Screen Frame with doors completely rotated so that the doors extend vertically and with a partially deployed folding screen and associated screen holder in an embodiment disclosed herein.

FIG. 1E presents a front view of the Folding Screen Frame with doors completely rotated so that the doors extend vertically and so that these are locked into position with locks associated with the deployable screen holder in an embodiment disclosed herein.

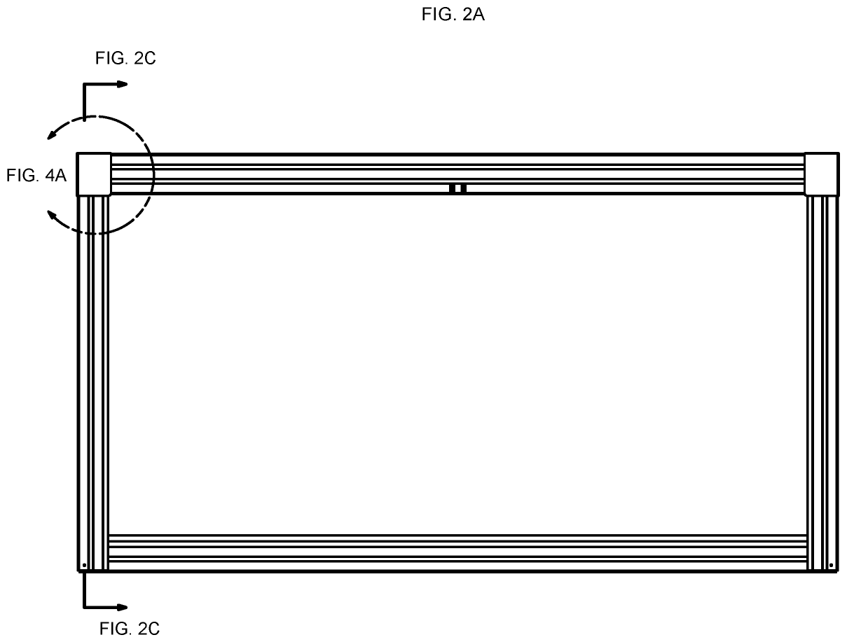

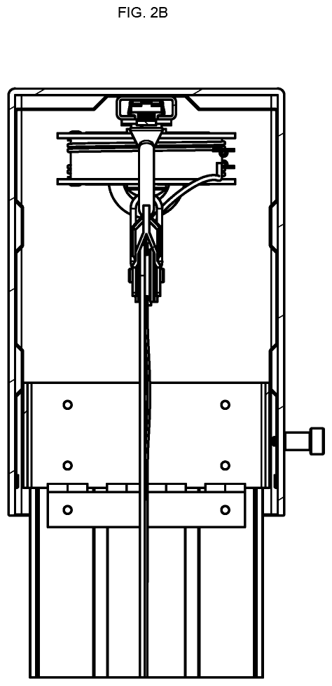

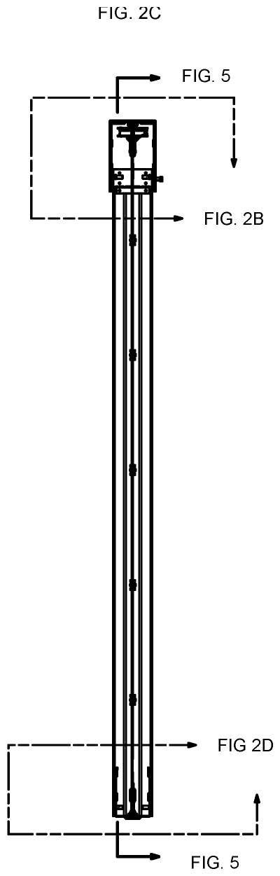

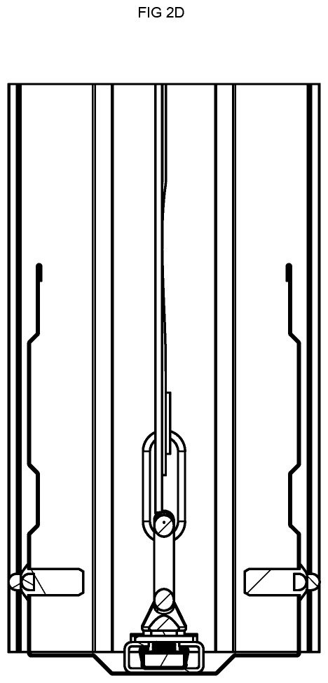

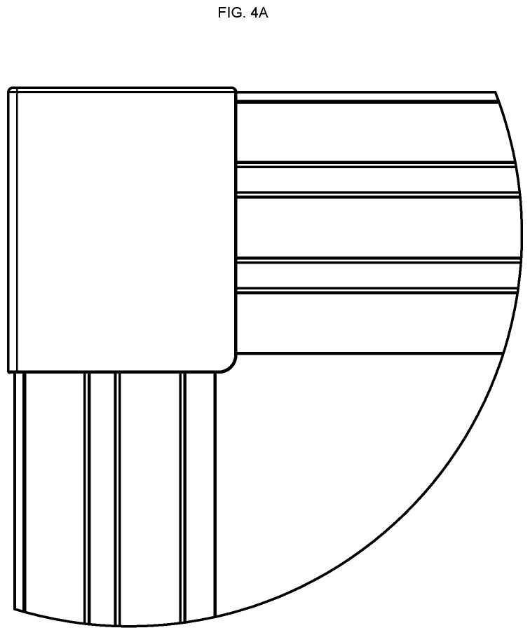

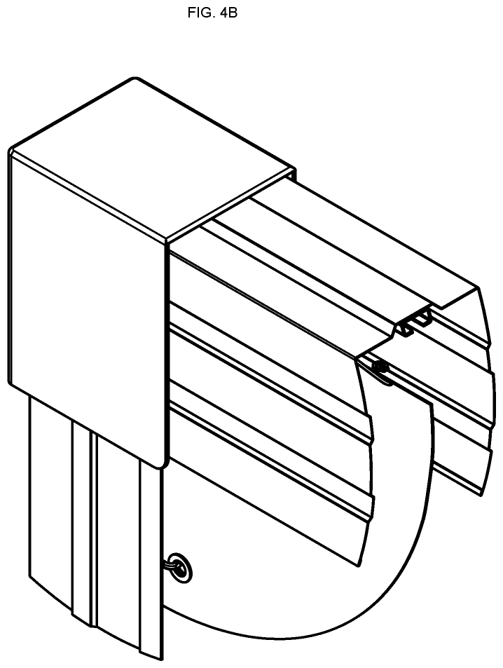

FIG. 2A presents a front view of a Folding Screen Frame in an embodiment disclosed with the screen holder fully deployed and locked with the fully deployed vertical doors in an embodiment described herein. The image shows two cross section lines; a first having a top front view of the leftmost portion of the Folding Screen Frame shown in FIG. 4A; and a right looking cross section as shown of the entire Folding Screen Frame with screen and screen holder fully deployed with doors locked with the bottom of the screen holder as shown in FIG. 2C.

FIG. 2B presents a closeup cross section view as marked in FIG. 2C so as to visualize the location of the retractor wheel 13 attached to the inside top of the cover 8 and also shows the beginning of the pulley system within the Folding Screen Frame in an embodiment described herein.

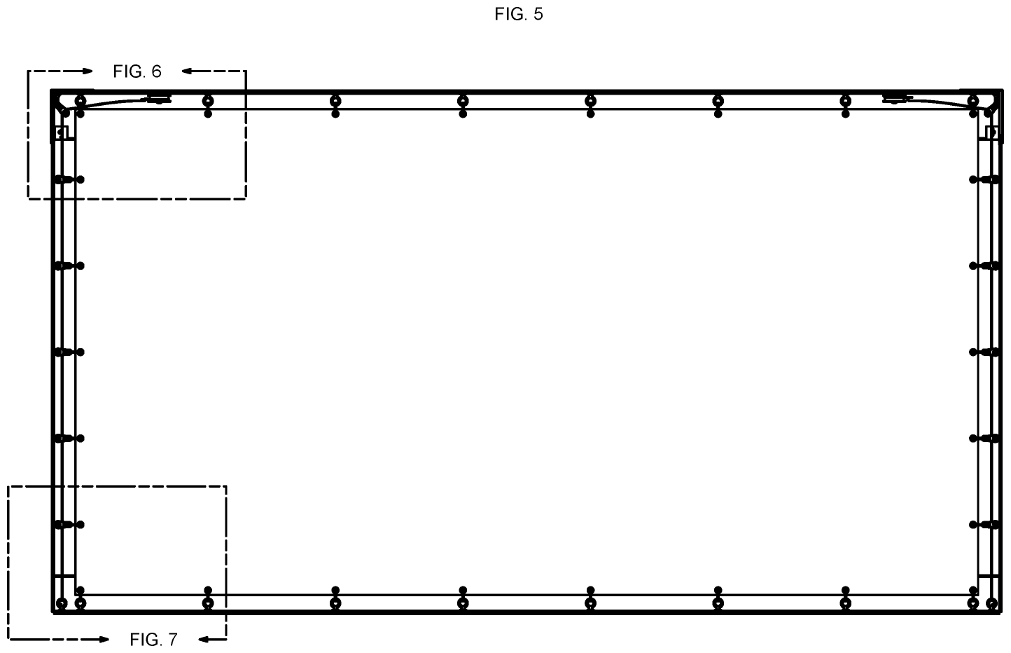

FIG. 2C presents the view described in FIG. 2A showing a right looking cross section of the Folding Screen Frame with screen and screen holder fully deployed with doors locked with the bottom of the screen holder. A section marked as FIG. 5 shows how the screen completely extended outwards is attached to the pulley system at the inside top of the cover and attached to the screen holder inside surface. A section marked 2B shows a closeup cross section view as marked so as to visualize the location of the retractor wheel 13 attached to the inside top of the cover 8 and also shows the beginning of the pulley system within the Folding Screen Frame. A section marked FIG. 2D shows the bottom of the deployed screen holder in an embodiment described herein.

FIG. 2D shows the bottom of the deployed screen holder in an embodiment described herein. Here the spring plungers have their nose or ball extended to lock the door in place. Two spring plungers 18 have their barrels welded within the screen holder 4 in a first mounting hole and a second mounting hole respectively such that the first spring plunger nose is disposed facing the front of the cover whilst the second spring plunger nose is disposed facing the back of the cover. Once mounted each spring plunger is disposed such that their respective noses are movably insertable within a single one of two locking holes found near the respective ends of each respective door. When the screen holder is deployed out of the cover and reaches its greatest extension therefrom and the doors are rotated completely such that these are disposed vertically, then the doors are lockable in association with the screen holder using these locking holes found near the free ends of the doors.

In this manner, a front locking hole for the first spring plunger nose and a back locking hole for the second spring plunger nose engage therewith such that a first door is locked together with the screen holder; this is repeated with two other spring plungers on the other side thereby attaching the other door using two holes therein to the other side of the screen holder. Thus, their respective movable first spring plunger nose and second spring plunger nose are movable outwards to pass through a single one of these holes (a front locking hole and a back locking hole) thereby locking the doors into a vertical open mode of operation. As previously stated, the other door 6 is similarly locked into an open mode on the other side of the Folding Screen Frame. To release the locking engagement, a user would press the noses thereby detaching the door ends from the screen holder.

FIG. 3A presents a side view cross section of the Folding Screen Frame in an embodiment disclosed herein. An outside cover 8 made from metal or rigid PVC is formed as an upside down U shaped member having two open ends; one at either end of the cover 8 and opposite each other. Attached to either open end of the cover 8 is a single one of two hinge plates 10 (not shown in this view but shown in FIG. 8A-8B) attached by welding. These hinge plates 10 serve to attach a single one of two doors, one door to each hinge plate 10 (the hinge itself is a spring loaded barrel type hinge loaded between two small wings 14, 15) using two spring hinges one for each door. Thus, a first spring hinge has a wing 14 attached to a first hinge plate 10 (welded or using screws) and the other wing 15 would attach to a door 5 (welded or using screws). The other door 6 is attached similarly to the other plate 10 at the other side of the cover 8.

Within this cover 8 is a corresponding smaller U shaped member forming a screen holder 4 that is sized to fit within the confines of the outside cover 8 thereby protecting the screen 12 that it is holding from the elements. The screen is attached to a first attachment assembly that is in turn attached to the inside top of the cover 8 running along an upwardly disposed longitudinal depression. The bottom of the screen 12 is attached to a second attachment assembly that is in turn attached to the inside bottom of the screen holder 4 running along a downwardly disposed longitudinal depression therein.

It should be apparent from the drawings that the outer surface of the cover 8 has two inwardly directed longitudinal depressions on the front and back sides for cosmetic and aerodynamic reasons. Similarly, the screen holder 4 has a varied surface having depressions therein. The doors 5, 6 have similar contours having longitudinally disposed depressions. Finally it should be apparent that the spring plungers are in their closed positions with their respective noses retracted into their respective bodies as they are pushed back therein by contact with the inner surface of the doors 5 or 6 as there are no holes to engage in this view (as the rotation of the respective door has placed it in a position where there is no hole therein) which is opposite the open nose position in FIG. 2D.

FIG. 3B presents a front view of a central portion of the outside cover having two mounts; each mount is formed from a set of two small rivets mounting a plate to the cover 8. These plates have a central hole through the plate and a corresponding hole in the metal surface of the cover 8 for welded attachment of the barrel of a spring plunger handle 17. This spring plunger handle 17 is used to lock the cover into a closed configuration by engagement with corresponding locking holes on the front surface near the ends of either door 5, 6; thus, when the doors are rotated into position on their respective hinges this thereby moves the aforementioned each locking hole into alignment with a single central hole of the metal plate/single central hole in the metal surface of the cover; at this point the spring plunger handle 17 nose extends therethrough and locks these two together. Manipulation by (turning, twisting or pulling depending on type) of a spring plunger handle 17 causes its nose to retract thereby releasing a respective door from the cover.

FIG. 4A presents a closeup front view of a top front view of the leftmost portion of the Folding Screen Frame shown in FIG. 2A in an embodiment described herein.

FIG. 4B presents a closeup perspective view of the top leftmost portion of the Folding Screen Frame in an embodiment described herein. A cross section of a portion thereof is also shown.

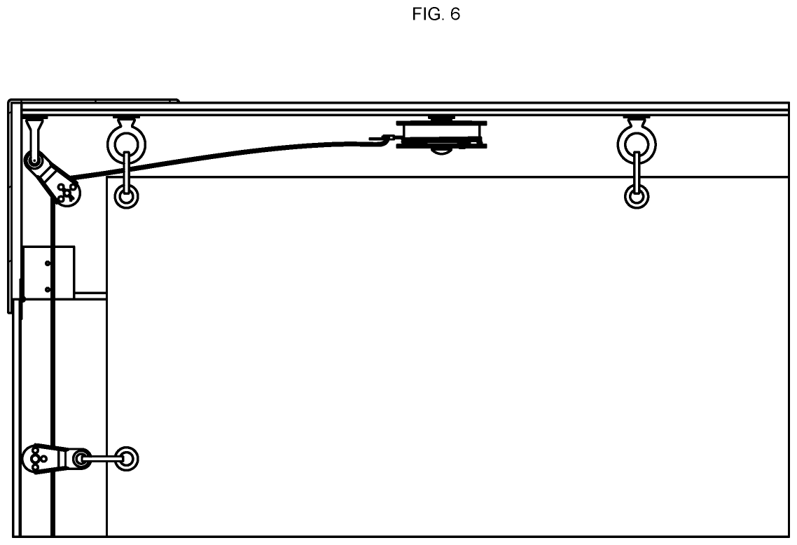

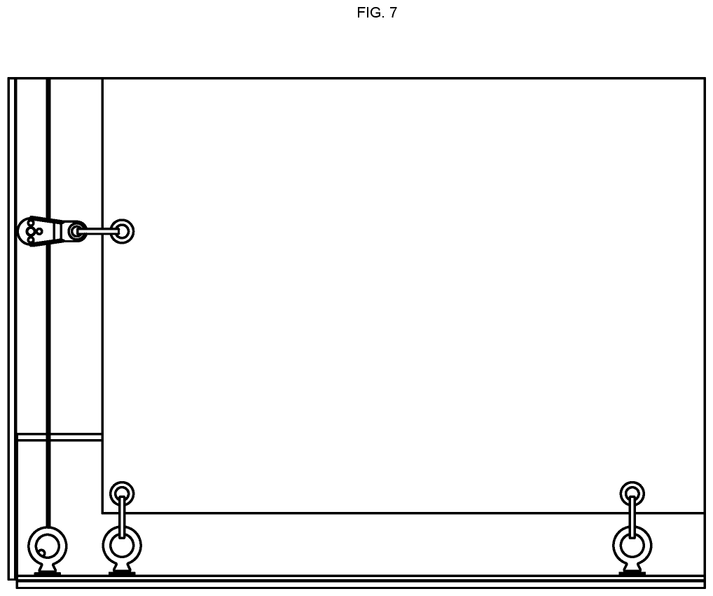

FIG. 5 presents a closeup front view of that sectioned in FIG. 2C showing the screen attached to the inner top portion of the cover 8, and the bottom of the holder 4 in an embodiment disclosed herein. Here two further sections are shown a top left section is shown directed to FIG. 6 and a bottom left section is shown directed to FIG. 7. There are two retractor wheels attached to the top inner portion of the cover one for each door; these are disposed one close to one end and one close to the opposite end of the inside portion of the cover 8. Each retractor wheel along with associated pulleys forms a separate system for opening and closing a door 5, 6 and extending and retracting the screen holder 4.

The pulleys are threaded with the wire or cable tied to the retractor wheel and are free floating with the exception of a first pulley attached to the inner top portion of the cover 8 (using an eyebolt 2 or dedicated integral mount) and the final attachment of the wire, cable to an inner surface of the screen holder 4 (using an eyebolt 2). Thus, these rely on the stiffness of the first and final connection to straighten the screen 12. The screen 12 itself is attached to the inner portion of the cover 8, and to the screen holder 4 using either eyebolts 2 and elastic rope 3 or the pulleys connected using elastic rope 3 as described further below.

FIG. 6 presents a front view of a top left section of FIG. 5 showing how the screen 12 is held to the inner top portion of the cover 8. Here a single retractor wheel 13 is attached to the top inner portion of the cover 8 near the left side thereof. The wheel has an attached spooled wire or cable that is threaded through a series of pulleys that are free floating with the exception of a first one attached to the top inner portion of the cover 8 using an eyebolt (with an integral annular supported pulley or dedicated integral mount) and to a last fixed point attached to an inner bottom portion of the screen holder 4. The screen 12 is itself attached along a number of its attachment points using integral annular devices to the inside top portion of the cover 8, to various free floating pulleys 20 and to the bottom inner portion of screen holder 4. The screen holder 4 and cover 8 attachments are accomplished using eyebolts 2 (attached by welding, threaded hole or mount to the appropriate portions of the screen holder 4 or cover 8) that are in turn threaded with elastic rope 3 that itself is likewise threaded into an annulus of the screen 12 and back tied to itself thereby locking these together as a loop tie. The pulleys are attached along either left or right side of the screen using annuli of the screen having elastic rope placed therein and on into an integral annular portion of a pulley and tied to itself forming a loop completing the engagement.

FIG. 7 presents a bottom left section of FIG. 5 showing how the screen 12 is held to the screen holder in an embodiment disclosed herein. FIG. 7 presents a front view of the bottom left section view of FIG. 5 showing the attachment of the screen 12 to the inner portion of the screen holder 4 using a set of eyebolts 2 that are attached (welded, screwed into a pre-threaded hole, locked with a bolt nut combo or similar attachment mechanism) to the inner bottom portion of the screen holder 4 using screen 12 pre-installed annuli and pieces of elastic rope. These eyebolts 2 each in their own turn is threaded with an elastic rope that is also threaded within a single annulus of the screen 12 and the rope is tied to itself forming a loop; this thereby holds the screen 12 to the screen holder 4.

The screen holder 4 is also movably attached to the right and left side of the screen using the cable or wire; this cable or wire is inserted onto one or more wheels of corresponding one or more free floating pulleys 20 and using a plurality of pieces of elastic rope is movably attached to screen 12. These one or more pulleys 20 each have an end having an annular attachment point so that a piece of elastic rope 3 is placed within it and through a single annuli of the screen 12 on the right or left side of the screen 12 whereupon it is attached back to itself forming a loop through sewing, adhesive, heat treatment or other means. Upon reaching the inner bottom portion of the screen holder 4, the cable or wire is tied onto an eyebolt that has been welded or held in place as previously described (welded, screwed into a pre-threaded hole, locked with a bolt nut combo or similar attachment mechanism) to the extreme leftmost position of screen holder 4. A duplicate eyebolt, pulleys, elastic rope, attachment to a duplicate cable or wire is found on the right side of the inner bottom portion of the screen holder 4.

FIG. 8A presents an assembly view of the Folding Screen Frame showing how various components come together in an embodiment disclosed herein. The view also shows three other views including FIG. 8B at upper left, FIG. 8C at middle top and FIG. 8D at bottom left showing various features to be described herein. The cover 8 is shown separated from the two doors 5, 6 that rotate on hinges attached to a hinge plate that serves as end caps for the cover 8. Additionally, the figure shows the screen holder 4 at bottom that is associated with the folding screen 12 at center. Additionally, a final trademark carrying poly extruded cap is shown above and outside of the cover 8 and hinge plate serving as an end cap 7 for the cover 8.

FIG. 8B shows how various features of the upper left of the Folding Screen Frame are assembled in an embodiment disclosed herein. It should be understood that the same features herein described are duplicated on the other side of the Folding Screen Frame. The retractor wheel 13 has a bolt 1 placed within a central hole of the retractor wheel 13 and as it exits from the hole, the bolt 1 passes into a lock washer 11 then through a fender washer 9 and on into steel rail nut 16; the steel rail nut 16 was slid within the rail 19 and is welded thereto. It should be understood that steel rail 19 has been welded to an upwardly centrally disposed longitudinal depression on the inside top of cover 8. Further, the steel rail is a downwardly disposed U shaped longitudinal device whose downwardly disposed ends curl inwards towards each other creating a thin longitudinal slit. Thus, a steel rail nut 16 welded therein can not exit through this slit as it is both welded to the steel rail 19 and incapable of passing through the thin slit which is much smaller than the length, width, and or height of the steel rail nut 16.

A wire or cable is wound about the circumferential surface of the retractor wheel 13 and tied thereto with a lock notch on the outer surface of one of two integral flanged surfaces; these extend from the outer surface of the retractor wheel creating a loading space for the wire or cable on the circumference of the retractor wheel 13. The wire or cable extends further to the left and is threaded onto a wheel within a pulley 20. This pulley 20 is attached to the inside top surface of the cover more specifically within the rail 19 that has as before had another steel rail nut 16 slid within the rail 19 and welded at an appropriately spaced distance. First the pulley has an integral annular attachment end that is attached to an eyebolt 2; this eyebolt 2 has an end that passes into a lock washer 11 then through a fender washer 9 and on into steel rail nut 16 that as we discussed above is placed within the steel rail 19 and welded thereto.

As the wire or cable exits from the pulley it passes down to another wheel pulley 20 that has an integral annular end that is attached to an annulus of the screen 12 using an elastic rope 3 attached to itself after being threaded through the screen annulus and the pulley annular end; this is repeated on down as described previously thereby creating a plurality of pulley to screen annuli attachments on both the left and right sides. Annuli are disposed about the periphery of the screen 12; each of the top horizontally disposed annuli of the screen 12 are attached thereto as follows. First an elastic rope 3 is threaded within the annulus and on into an eyebolt 2 whose end passes into a lock washer 11 then into a fender washer 9 and on into steel rail nut 16; as was discussed above the rail nut 16 is placed within the steel rail 19 and welded thereto. Finally, attached to either open end of the cover 8 is a single one of two hinge plates 10 attached by welding. These hinge plates 10 serve to attach two doors to the cover, one door to each hinge plate 10 (formed as a spring loaded barrel hinges having two small wings 14, 15). Thus, using a first spring hinge would have a wing 14 attached to a first hinge plate 10 and the other wing 15 would be attached to a door 5. The other door 6 is attached similarly to another plate 10 at the other side of the cover 8.

FIG. 8C shows how various features of the middle cover of the Folding Screen Frame are assembled in an embodiment disclosed herein. This view presents a closeup front view of a central portion of the cover 8 having two mounts; each mount is formed from a plate attached using a set of two small rivets (through rivet holes in the plates and corresponding holes in the cover 8) mounting the plate to the cover 8. These plates have a central hole through the plate and a corresponding hole in the metal surface of the cover 8 for insertion of a spring plunger handle 17 which is weld thereto. This spring plunger handle 17 is used to lock the cover into a closed configuration along with corresponding locking holes near the ends of either door 5, 6 when the door holes are rotated into position on their respective hinges. Each spring plunger handle 17 has a nose that extends or retracts by pulling, rotating, turning or similar modality. Thus, the nose of each spring plunger handle 17 is designed to enter through the hole in a corresponding plate and on into a hole in the cover 8 and into corresponding hole in a door 5, 6.

The figure also shows how a screen 12 top based annulus is attached to steel rail 19 using an elastic rope 3; the rope 3 is threaded through the annulus and through the hole in an eyebolt 3 and tied back to itself. The eyebolt's end passes into a lock washer 11 then into a fender washer 9 and on into steel rail nut 16. As was discussed above the rail nut 16 is placed within the steel rail 19 and welded thereto.

FIG. 8D shows how various features of the bottom left of the Folding Screen Frame are assembled in an embodiment disclosed herein. Another steel rail 19 runs along the centrally disposed longitudinal depression at the inner bottom of the screen holder 4. This steel rail in contradistinction with the one welded to the cover 8 is disposed with its longitudinal slit directed upwards, thereby forming a U shaped steel rail 19 having top ends curling inwards towards each other. Because of this, integral annuli at the bottom of the screen 12 are attached to the steel rail using the same devices as before. First, the elastic rope 3 is threaded through an annulus and through the hole in an eyebolt 2 and tied back to itself. The eyebolt's end passes into a lock washer 11 then into a fender washer 9 and on into steel rail nut 16. As was discussed above the rail nut 16 is placed within the steel rail 19 and welded thereto.

Two spring plungers 18 are placed into front and back holes on the corresponding surface of the screen holder 4 and have their respective barrels welded thereto. These are used to extend their respective noses on into corresponding holes in the front and back of door 5, 6 thereby locking the doors into a vertical open mode of operation; this when the first spring plunger nose extends into a first hole on the front portion of the screen holder and the second spring plunger nose extends into a second hole on the rear portion of the screen holder. It should be understood that the screen holder 4 is a U shape so that the rear vertical portion of the U is the rear portion and the front vertical portion of the U is the front portion. The other door 6 is similarly locked into an open vertical mode on the other side of the Folding Screen Frame using another set of two spring plungers 18. Pressing the noses of the spring plungers have the intended effect of releasing the doors from the screen holder 4. A user can then use the retraction power of the retractor wheel to retract the screen holder back into the cover and lock it using spring plunger handles and the corresponding door locking holes when the doors are rotated upwards into a closed position.

The above-described embodiments are merely exemplary illustrations of various implementations set forth for a clear understanding of the principles of the invention. Many variations, combinations, modifications or equivalents may be substituted for elements thereof without departing from the spirit and scope of the invention. Therefore, it is intended that the invention not be limited to the particular embodiments as disclosed, but that the invention will include all the embodiments falling within the scope of the appended claims.

1. A screen system comprising:
a cover having
a screen attached to the cover.

2. The screen system of claim 1, further comprising:
a screen holder disposed within the cover such that the screen is attached to the screen holder.

3. The screen system of claim 1, further comprising:
a retractor attached to the cover and movably attached to the screen and to a screen holder.

4. The screen system of claim 1, further comprising:
a first movable member attached to the cover.

5. The screen system of claim 4, further comprising:
a second movable member attached to the cover.

6. The screen system of claim 4, further comprising:
wherein the first member is locked into position with a portion of a screen holder inserted within the cover and attached to the cover.

7. The screen system of claim 6, further comprising:
wherein a second movable member attached to the cover is locked into position with another portion of the screen holder inserted within the cover and attached to the cover.

8. The screen system of claim 1, further comprising:
a vertical side of the screen attached to the cover using a pulley.

9. The screen system of claim 1, further comprising:
wherein the cover is enclosed and has a lower opening for insertion of a screen holder attached to both the cover and to the screen.

10. The screen system of claim 9, further comprising:
wherein the screen holder is movably attached to the cover.

11. The screen system of claim 10, further comprising:
wherein the screen holder is attached movably to the cover using a retractor and the screen holder is movably attached to the screen using the retractor.

12. The screen system of claim 11, further comprising:
a cable attached to the retractor and threaded within the grommet for further attachment to the screen holder.

13. A screen covering system comprising:
a cover having a screen attached thereto; and
a screen holder attached to the screen and attached to the cover.

14. The screen covering system of claim 13, further comprising:
a rail attached to the cover and to the screen.

15. The screen covering system of claim 14, further comprising:
wherein the screen is attached to the rail.

16. The screen covering system of claim 13, further comprising:
a door movably attached to a first end of the cover.

17. The screen covering system of claim 13, further comprising:
a plate attached to the door and to the cover.

18. The screen covering system of claim 17, further comprising:
a hinge attaching the plate to the door and to the cover.

19. A container comprising:
a screen attached to and enclosed within the container
wherein the screen is attached to a retractor that is attached to the container.

20. The theater screen container of claim 19, further comprising:
a first door movably attached to the container lockable into an OPEN mode and a CLOSED mode using locks.
